(19) United States
(12) Patent Application Publication
(10) Pub. No.: US 2026/0369252 A1
(43) Pub. Date: Nov. 19, 2026

(54) Devices and Methods for Improving a User's Grip on an Instrument Pick

(71) Applicant: Lawrence J. Hierholzer, Trabuco Canyon, CA (US)

(72) Inventor: Lawrence J. Hierholzer, Trabuco Canyon, CA (US)

(21) Appl. No.: 19/632,993

(22) Filed: Mar. 30, 2026

Related U.S. Application Data
(60) Provisional application No. 63/779,983, filed on Mar. 28, 2025.

(51) Int. Cl. G10D 3/173

(52) U.S. Cl. CPC G10D 3/173

(57) ABSTRACT

Devices are described for improving the grip on an instrument pick. The devices may include any combination of a surface attachment to improve friction and/or adhesion to the surface of the pick and/or in devices that facilitate attachment of the pick to the user. The embodiments shown and described herein may be used together or separately.

### BACKGROUND

Traditionally instrument picks are planar pieces of wood or plastic with round and/or pointed corners designed to pluck at a stringed instrument.

Applicant has made progress in the pick industry to manufacture picks of superior features and qualities. For example, contoured surfaces may be used to generate unique sounds and improve handling.

However, there is still little advancement in the evolution of picks; particularly as it concerns the improved handling and gripping of a pick. A musician may use a pick for many hours while playing a stringed instrument. Pinching a pick to provide a secure grip while it is used to pluck at strings can therefore become tiring over time. In addition, a musician's fingers may become slick during a performance from sweat or condensation from a drink. The musician's grip on a pick may therefore become compromised or less stable.

### SUMMARY

Exemplary embodiments shown and described herein include devices for improving the grip on a pick. The devices may include any combination of a surface attachment to improve friction and/or adhesion to the surface of the pick and/or in devices that facilitate attachment of the pick to the user. The embodiments shown and described herein may be used together or separately.

In an exemplary embodiment, the device for improving grip on an instrument pick comprises a surface attachment to be coupled directly to the pick. The surface attachment includes an adhesive surface that is configure to increase friction on the surface of the pick.

Shown and described herein are devices for improving grip that include surface attachment(s) for instrument picks having adhesives. The devices for improving grip are configured to be attached to the pick surface and may be positioned on a portion of the pick to improve grip.

The adhesive surface attachment may be configured to stick to the pick's surface as well as to the user's finger(s).

The adhesive surface attachment may include different configurations as shown and described herein and as would be understood by a person of skill in the art in view of the description herein. For example, an optional configuration may use a plurality of adhesive surface attachments positioned over a portion of the pick's surface. Other optional configurations may include one or more adhesive surface attachment attached to the pick surface.

Optional configurations of the adhesive surface may include contoured surfaces to further improve grip on the pick. For example, an inward surface of the adhesive may attach directly to a pick's surface. The outward surface of the adhesive may be on the side opposite the inward surface of the adhesive and may face outward toward the user's finger (or may touch the user's finger when in use). The outward surface may be generally flat; may be concave or curved so that it forms a rounded protrusion from the pick's surface when attached to the pick; may be convex or curved to create a cradle or indentation for resting a finger; may be angled; tapered; grooved; textured, ridged; contoured; cross-hatched; patterned; have one or more protuberances; or other surface features; or any combination thereof to improve grip of the pick, position a finger relative to the pick in a desired location, and/or provide an ergonomic configuration for the pick.

The adhesive surface attachments shown and described herein may be flexible to contour to the surface of a pick.

The adhesive surface attachments shown and described herein may include a compressible material that provides a cushion when pressed by a user.

The adhesive surface attachments shown and described herein may comprise pressure-sensitive adhesives pre-formed in one or more shapes. The preformed adhesives may comprise globules of adhesive configured in a desired shape, including an outer perimeter shape, and/or outward surface contour.

The adhesive surface attachments may comprise a kit of adhesive surface attachments in which a plurality of adhesive surface attachments are provided on a transfer sheet so that a user may select one or more desired adhesive surface attachments for application onto a pick's surface.

The adhesive surfaces and/or set of adhesive surfaces may be shaped individually and/or as a set to correspond to one or more different pick surfaces, pick shapes, and/or pick sizes.

The adhesive surfaces may be provided individually or as a set and may comprise a transfer sheet for storing, selling, and/or positioning the adhesive surfaces on a pick surface. For example, one or more adhesive surfaces may come on a transfer sheet with individual adhesive surfaces separated in a desired pattern and/or at a desired distance. The adhesive surfaces may be configured to be positioned and attached to the pick to transfer the adhesive surfaces from the transfer sheet in the desired pattern onto the pick. A second protective sheet may be positioned on top of the adhesive surfaces to protect the adhesion during storage.

The adhesive surface(s) may be positioned and stored between two laminate surfaces. The first surface may be a protective sheet configured to protect the adhesive surface(s) until used and may contact the inner surface configured to contact the pick surface. The protective sheet may be removed to expose one or more of the adhesive surfaces and the pick contacted and pressed against the exposed adhesive surface(s). The second surface may be a transfer sheet configured to contact the outward surface of the adhesive surfaces and may be removed after the one or more adhesive surfaces are attached to the pick surface, leaving the adhesive surface(s) attached to the pick.

The transfer sheet may include a pick outline or other markers to assist with positioning the adhesive surfaces in a desired orientation or location on the pick.

The description shown and described herein may include attaching the surface attachment(s) according to embodiments described herein to an instrument pick and using the instrument pick to make noise from an instrument. The adhesive surface attachments may therefore be positioned and attached on the surface of an instrument pick away from a picking edge or corner and may be positioned and attached to facilitate a user gripping the pick.

The adhesive surfaces and methods of using the adhesive surfaces may include one or more adhesive surfaces having a shape and/or size that may be larger than the pick to which it is intended to be attached. The adhesive surface may be directly attached and/or may be stretch during attachment to the pick surface. The excess of the adhesive surface extending past the perimeter edge of the pick may thereafter be removed so that the adhesive surface and the pick are the same size and shape for at least a portion or all of the pick. In an optional embodiment, the adhesive surface may be cut to remove the excess. In an optional embodiment, the adhesive surface may be pulled against the terminal edge of the pick such that the adhesive surface tears along the end of the pick. Any overage of the adhesive surface may therefore be cut, torn away, or otherwise removed from the pick.

The adhesive surfaces may be configured to be stacked so that a user may generate different contours, thicknesses, cushion, etc. by the addition or deletion of additional adhesive surfaces.

An instrument pick having one or more adhesive surfaces attached to the pick to improve grip and control of the grip on the pick by the musician.

The adhesive surfaces may be positioned on the pick to create a desired pattern and/or shape on the pick to generate a desired grip and/or feel of the pick.

The adhesive surface(s) may be stacked on top of each other to generate a desirable thickness and/or cushion feel to the pick.

Exemplary embodiments of the adhesive surfaces and methods for creating grip using the adhesive surfaces as shown and described herein may also include powdering the adhesive surface to increase/decrease friction on the outer surface of the adhesive surface and/or control the stickiness of the adhesive surface.

Exemplary embodiments of a pick to use with the adhesive surfaces described herein may include grooved, contoured, textured, or otherwise featured surface to receive the adhesive surfaces, position the adhesive surfaces in a desired location, and/or assist in the retention of the adhesive surfaces onto the pick's surface.

In a second embodiment, the device for improving grip on an instrument pick comprises devices that facilitate attachment of the pick to the user. As shown and described herein the attachment device includes a cradle for retaining the pick and a connector for coupling the attachment device to a finger of the user.

The attachment device may comprise one or more apertures to permit contact with one or more surfaces of the pick. In an optional example, one aperture may be sized to permit the striking end of the pick through the aperture but not permit the entire pick through the aperture so that an edge of the one aperture contacts the perimeter edge of the pick to retain the pick in place. In an optional example, another aperture may be sized to permit contact with a gripping surface of the pick such as a side surface of the pick. The other aperture may be smaller in diameter in at least one direction compared to the pick at the corresponding location of the pick to the cradle when in an in use configuration. The cradle having the other aperture may therefore be configured to retain the pick between the user's finger, and the inside surface of the cradle adjacent the second aperture edge, but allow contact with a pick surface through the other aperture by another of the user's fingers.

The attachment device, the cradle may comprise a ledge or shaped surface to contact and/or approximate a portion of the perimeter edge of the pick to retain the pick in a desired position. The ledge may be a projection on an inside surface of the attachment device configured to contact a top terminal end of the pick during use. In an optional embodiment, the pick may be retained between the contact of the pick in the one aperture and the ledge.

The attachment device may include a connector. The connector may be configured to couple the attachment device to a user's finger. The connector may include alternative connections, such as a mated projection and aperture, ratchet, button, hook and loop, tie, other coupling features and/or mated features, and any combination thereof.

The attachment device may include one or more extensions from the cradle that are configured to wrap around a portion of the user's finger and extend through an attachment aperture on an opposing side of the cradle from which the extensions project.

The extension(s) may have a cross-sectional size and/or shape smaller than the size and/or shape of the attachment aperture so that the extension may fit through the attachment aperture.

The extension(s) may have projections extending therefrom that create a cross-sectional size and/or shape that is larger than attachment aperture such that the projections abut an edge around the attachment aperture and retain the extension in place and does not permit the projection to pass through the attachment aperture.

The projections and/or the material defining the attachment aperture may be flexible so that the projections and/or the attachment aperture may deform to permit the projections to pass through the attachment aperture in at least one direction.

The projections may be shaped to facilitate passage through the attachment aperture in a first direction but impede passage through the attachment aperture in a second direction, opposite the first direction.

The projections and/or material defining the attachment aperture may be flexible to permit passage of the projections through the attachment aperture under application of sufficient force to the extensions to pull the extension through the attachment aperture but may retain the extension in a desired relative position and not permit the passage of the projections through the attachment aperture with insufficient force on the extension.

The adhesive surface and/or attachment device may be used in combination. For example, the adhesive surface may be used to couple the pick to the attachment device. As an example, the adhesive surface may couple to the pick surface and be exposed through at least one aperture of the attachment device cradle to permit contact of the adhesive surface between the pick and the user's finger.

### DRAWINGS

FIG. 1 illustrates a pick having an exemplary embodiment of the device for improving grip attached thereon in an exemplary configuration.

FIG. 2 illustrates a pick having an exemplary embodiment of the device for improving grip attached thereon in an exemplary configuration.

FIGS. 3A-3B illustrate a front view and side view of a pick having an exemplary embodiment of the device for improving grip attached thereon in an exemplary configuration.

FIGS. 4A-4B illustrate a front view and side view of a pick having an exemplary embodiment of the device for improving grip attached thereon in an exemplary configuration.

FIGS. 5A-5E illustrate exemplary embodiments representing one or more steps of the method for improving grip using the device for improving grip according to embodiments herein.

FIGS. 6A-6E illustrate exemplary embodiments representing one or more steps of the method for improving grip using the device for improving grip according to embodiments herein.

FIGS. 7A-7C illustrates a pick (FIG. 7C) with front view and side view of an exemplary embodiment of the device for improving grip according to exemplary embodiments described herein.

FIGS. 8A-8B illustrates a front view and side view of an exemplary embodiment of the device for improving grip with a pick positioned therein according to exemplary embodiments described herein.

FIG. 9 illustrates a side view of an exemplary embodiment of the device for improving grip with a pick in an in use configuration.

FIG. 10 illustrates an exemplary embodiment including multiple other embodiments for improving grip used in combination with a pick.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention and are not limiting of the present invention nor are they necessarily drawn to scale.

Exemplary embodiments shown and described herein include devices for improving the grip on an instrument pick to be used with a stringed instrument. The devices may include any combination of a surface attachment to improve friction and/or adhesion to the surface of the pick and/or in devices that facilitate attachment of the pick to the user. The embodiments shown and described herein may be used together or separately.

Shown and described herein are devices for improving grip that include surface attachment(s) for instrument picks having adhesives. The devices for improving grip are configured to be attached to the pick surface and may be positioned on a portion of the pick to improve grip.

Shown and described herein are devices for improving grip that include devices that facilitate attachment of the pick to the user. As shown and described herein the attachment device includes a cradle for retaining the pick and a connector for coupling the attachment device to a finger of the user.

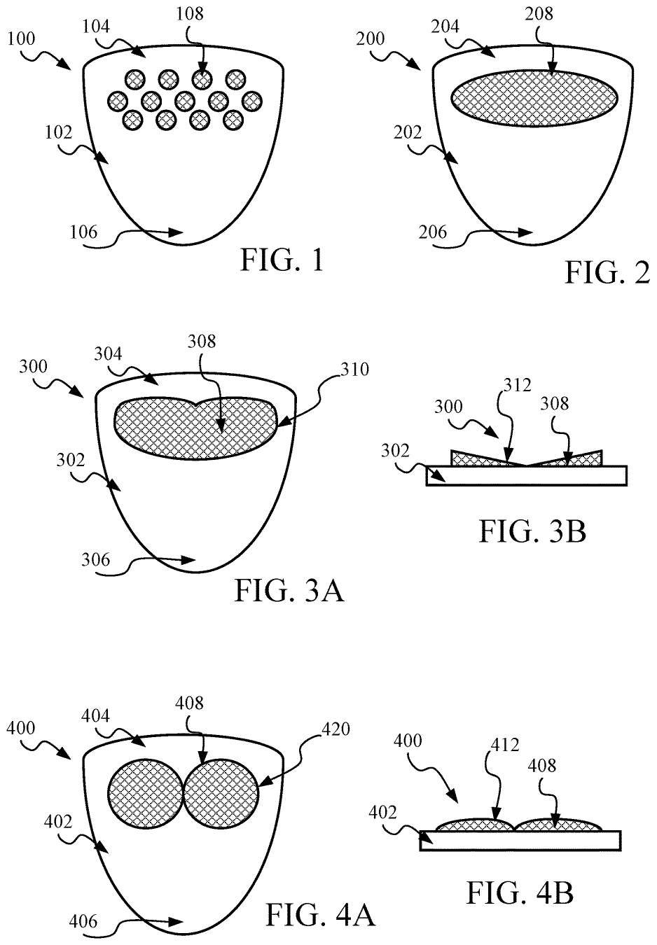

FIGS. 1-7 shown and described devices for improving grip that include surface attachment(s) for instrument picks having adhesives. The devices for improving grip are configured to be attached to the pick surface and may be positioned on a portion of the pick to improve grip.

FIG. 1 illustrates an exemplary device 100 for improving the grip of a pick 102 using surface attachments 108 comprising adhesives.

FIG. 2 illustrates an exemplary device 200 for improving the grip of a pick 202 using surface attachments 208 comprising adhesives.

FIGS. 3A-3B illustrate an exemplary device 300 for improving the grip of a pick 302 using surface attachments 308 comprising adhesives.

FIGS. 4A-4B illustrate an exemplary device 400 for improving the grip of a pick 402 using surface attachments 408 comprising adhesives.

As illustrated, each pick 102, 202, 302, 402 may have positioned thereon one or more surface attachments, 108, 208, 308, 408. The surface attachments may include opposing sides: a first side configured to contact a surface of the pick, the inward side, and a second side configured to face away from the pick and contact a user's finger during use, the outward side. In an exemplary embodiment, the inward side and/or the outward side comprise an adhesive.

A pick 102, 202, 302, 402 may have a gripping portion 104, 204, 304, 404 intended to be held by a user and a striking end 106, 206, 306, 406 to be used to pluck, strum, or contact strings of an instrument (not shown). As illustrated, the one or more surface attachments 108, 208,, 308, 408 may be positioned on, over, and/or adjacent to the gripping portion of the pick.

In an exemplary embodiment, the one or more surface attachments 108, 208, 308, 408 may be an adhesive so that the inward side and the outward side are sticky. In alternative embodiments, the one or more surface attachments may include a substrate in which a layer of adhesive is positioned thereon.

The one or more surface attachments 108, 208, 308, 408 may be flexible and/or compressible. The flexibility may permit the surface attachment to conform to the surface of a pick 102, 202, 302, 402. The compressibility may be selected for the comfort of the user and may provide a cushioned surface for positioning a finger thereon.

As seen by a comparison of FIGS. 1-4B, the surface attachments 108, 208, 308, 408 may be configured in one or more groups, with one or more shapes, sizes, and/or surface features.

FIG. 1 illustrates an exemplary configuration in which a plurality of surface attachments 108 are positioned on the pick 102 covering the gripping portion 104. Each surface attachment of the plurality of surface attachments includes a generally circular perimeter shape. Each surface attachment of the plurality of surface attachments may include an outer surface that is contoured. The contour of the outer surface may be in any shape. For example, the outer surface may be generally planar or may be domed or curved. The plurality of surface attachments may be positioned on the gripping portion 104 in any desired configuration or pattern. As shown, the plurality of surface attachments 108 are positioned in a grid, but other configurations are also contemplated herein such as to form lines, circles, ovals, and/or random arrangements.

FIG. 2 illustrates an exemplary configuration in which a single surface attachments 208 is positioned on the pick 202 covering the gripping portion 204. The surface attachment includes a generally ovoid perimeter shape. The surface attachment may include an outer surface that is contoured. The contour of the outer surface may be in any shape. For example, the outer surface may be generally planar or may be domed or curved. The curvature of the contoured outer surface may be inward or outward. For example, the curvature of the contoured outer surface may create a dome or projection on the surface of the pick. The curvature may also or alternatively be contoured to create an indentation on the surface attachment such as to create a recess for positioning a finger thereon. The surface attachment may be positioned on the gripping portion 204 in any desired orientation or location relative to the gripping portion 204. The location and/or orientation of the surface attachment 208 may be selected based on the desired gripping location of one or more fingers of the user while using the pick.

FIGS. 3A-3B illustrate an exemplary configuration in which a single surface attachments 308 is positioned on the pick 302 covering the gripping portion 304. The surface attachment includes a general heart-like or double, overlapping ovoid perimeter shape. The surface attachment may include an outer surface that is contoured. The contour of the outer surface may be in any shape as described with respect to the other embodiments shown herein. As illustrated, the outer surface may be generally planar or curved and may include a taper in one or more directions so that an indentation or projection is made in the surface attachment. As illustrated, the outer surface of the surface attachment 308 includes a double taper in which the outer edges of the surface attachment are thicker and the interior section of the surface attachment is thinner so that the outer surface tapers from the outer edges toward the middle of the surface attachment. The surface attachment may be positioned on the gripping portion 304 in any desired orientation or location relative to the gripping portion 304. The location and/or orientation of the surface attachment 408 may be selected based on the desired gripping location of one or more fingers of the user while using the pick.

FIGS. 4A-4B illustrate an exemplary configuration in which two surface attachments 408 are positioned in contact with each other to approximate the single surface attachment. The surface attachment includes a generally circular outer perimeter and are positioned adjacent to each other to create a double-circular perimeter shape. The surface attachment may include an outer surface that is contoured. The contour of the outer surface may be in any shape as described with respect to the other embodiments shown herein. As illustrated, the outer surface may be generally curved and create a generally domed shape. The surface attachment may be positioned on the gripping portion 404 in any desired orientation or location relative to the gripping portion 404. The surface attachments 408 may be positioned relative to each other to create indentations and/or projections on the surface of the pick to facilitate or define desirable gripping surfaces.

Although only one side of the pick is shown, one or both sides of the pick may have surface attachments. The one or both sides of the pick may have the same or different surface attachments.

The surface attachment shown and described herein may be configured to stick to the pick's surface as well as to the user's finger(s). One or both sides of the surface attachment may have an adhesive. One or both sides of the surface attachment may be without an adhesive.

The surface attachment may include different configurations as shown and described herein and as would be understood by a person of skill in the art in view of the examples provided. For example, an optional configuration may use one or more surface attachments positioned over a portion of the pick's surface. The outer perimeter shape of one or more of the surface attachments may be the same or different, and may be any of amorphous, circular, ovoid, rectangular, bulbous, heart-like, or any combination thereof. The outer surface of one or more of the surface attachments may be the same or different, and may be any of planar, curved, curved inward to create an indentation, curved outward to create a projection, tapered, or otherwise contoured.

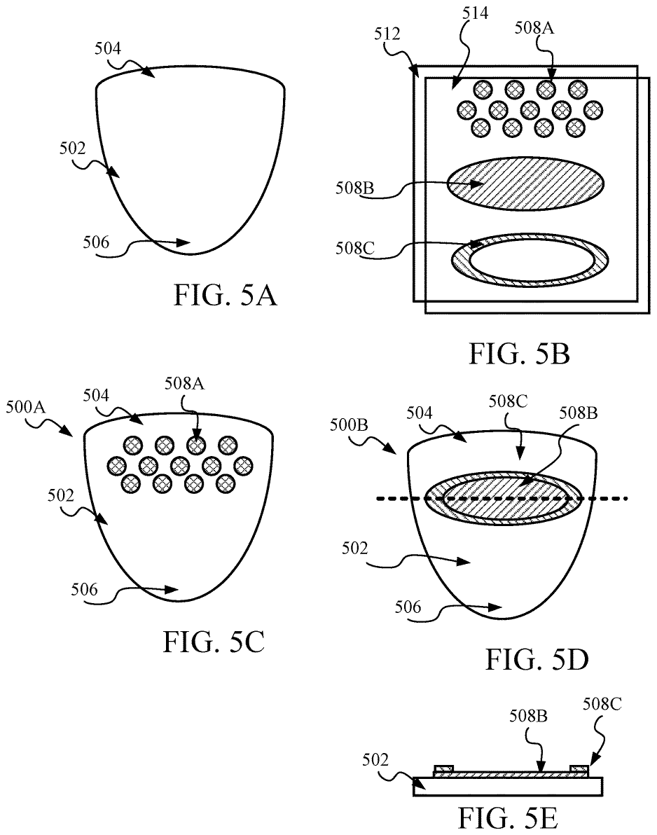

Exemplary configurations of the surface attachment are shown and described herein. The surface attachments may be molded to any two or three dimensional form or image. Exemplary options are illustrated herein such as the domed, concave, angled surface. However, any surface feature and/or texture may be provided including, for example, curved, bumps/protrusions, indentations, ridges, etc. The surface contours of the surface attachments may be formed directly in a single surface attachment, such as illustrated in FIG. 2 and/or through coupling separate surface attachments together, such as illustrated in FIGS. 5D-5E.

Exemplary embodiments of the surface attachments may be created by coupling separate surface attachments together as shown and described herein or as a single surface attachment. The surface attachment may be created from layers of adhesive and/or non adhesive in any alternating and/or patterned configuration.

Optional configurations of the surface attachment may include contoured surfaces to further improve grip on the pick. For example, an inward surface of the adhesive may attach directly to a pick's surface. The outward surface of the adhesive may be on the side opposite the inward surface of the adhesive and may face outward toward the user's finger (or may touch the user's finger when in use). The outward surface may be generally flat; may be concave or curved so that it forms a rounded protrusion from the pick's surface when attached to the pick; may be convex or curved to create a cradle or indentation for resting a finger; may be angled; tapered; grooved; textured, ridged; contoured; cross-hatched; patterned; have one or more protuberances; or other surface features; or any combination thereof to improve grip of the pick, position a finger relative to the pick in a desired location, and/or provide an ergonomic configuration for the pick.

The surface attachments shown and described herein may be flexible to contour to the surface of a pick.

The surface attachments shown and described herein may include a compressible material that provides a cushion when pressed by a user.

The adhesive surface attachments shown and described herein may comprise pressure-sensitive adhesives pre-formed in one or more shapes. The preformed adhesives may comprise globules of adhesive configured in a desired shape, including an outer perimeter shape, and/or outward surface contour.

FIGS. 5A-5E illustrate an exemplary use of one or more adhesive surfaces according to embodiments described herein.

FIG. 5A illustrates an exemplary pick that may be used with embodiments of the exemplary adhesive surfaces shown and described herein. The exemplary pick 502 may be of any shape and/or size and may have a gripping portion 504 and a striking end 506.

FIG. 5B illustrates an exemplary kit of surface attachments. As illustrated, a plurality of surface attachments 508A, 508B, 508C are provided. As illustrated, the plurality of different surface attachment may include different perimeter shapes, sizes, and/or outer surface(s) and/or may be the same surface attachments. Different surface attachment may be provided so that a user may select one or more desired surface attachments for application onto a pick's surface. The same and/or different surface attachments may be provided so that the user may select one or more desired surface attachments and permit the surface attachments to be removed from the pick and replaced with new ones as the adhesion of the surface attachments changes over time with use.

In an exemplary embodiment, the plurality of surface attachments are provided on a transfer sheet 512 so that a user may select one or more desired surface attachments for application onto a pick's surface.

The surface attachments and/or set of surface attachments provided as a kit may be shaped individually and/or as a set to correspond to one or more different pick surfaces, pick shapes, and/or pick sizes.

FIG. 5C illustrates an exemplary configuration in which a first set of surface attachments were selected from the transfer sheet 512 and coupled to the pick 502 to create a pick with improved grip 500A.

FIG. 5D illustrates an exemplary configuration in which a second surface attachment 508B and third surface attachment 508C were selected from the transfer sheet 512 and coupled to the pick 502 to create a pick with improved grip 500B.

As illustrated in FIG. 5D one or more surface attachments may be positioned on top of one another or overlapped to create any combination of surface contours on the surface of the pick.

As seen in FIG. 5E, which is the cross section of FIG. 5D at the dotted line, two surface attachments each with planar outer surfaces are staked to create a contoured outer surface. Specifically, a generally ovoid surface attachment 508B is positioned under a ring surface attachment 508C so that an indentation is created by the interior space of the ring surface attachment 508C.

The surface attachments shown and described herein may be configured to be stacked so that a user may generate different contours, thicknesses, cushion, etc. by the addition or deletion of additional adhesive surfaces. Different surface attachments may have the same and/or different sizes, perimeter shapes, outer surface contours, or any combination thereof. The combination of separate attachment surfaces may therefore be combined to configured a surface of a pick.

The surface attachments may be created or stacked to form cavities and/or pockets and/or include adhesive and/or non-adhesive contact so that the respective layers may contact and adhere and/or provide pockets therebetween. For example, if a second surface attachment 508B is positioned over the configuration of FIG. 5E, a pocket and/or cavity may be created between the respective surface attachments 508B.

Exemplary embodiments may create an air pocket so permit dynamic deformation of the surface attachment and accommodate an ergonomic contouring of the surface attachment to the user's finger.

Exemplary embodiments may create a pocket within the surface attachment and/or between the surface attachment and a pick. The pocket may be configured to accommodate and/or hold a component part. For example, the surface attachment may contain therein, within a pocket or molded or enclosed by the surface attachment, a chip, diode, solar cell, battery, or other electronic element(s). Electronic elements may be used to produce colors and/or lights, may store information, etc. For example, a memory may be included to store information such as contact information of a band, music, a link to a website or other location that may be read by a separate electronic device, etc. Another electronic device may be configured to communicate with the memory and retrieve the stored information. A band may, for example, use a pick with embodiments of the surface attachment coupled thereon having the electronic element as a business or calling card with their contact information contained on a memory of the electronic element that may be accessed by a mobile phone of a fan.

Exemplary embodiments of a surface attachment shown and described herein include two or more layers of two or three dimensional layers. Each layer may be flat and/or molded to one or more contours of one or more widths, cross sectional shape, surface contours, etc. Each layer may be of any combination of materials and/or properties including adhesive and/or non-adhesive, flexibility, compressibility, tackiness, biocompatibility, porosity, moisture absorption, etc. The layers may be configured and/or positioned to create an overall surface attachment configuration including a solid structure and/or a structure with pockets and/or cavities, and/or surface contours.

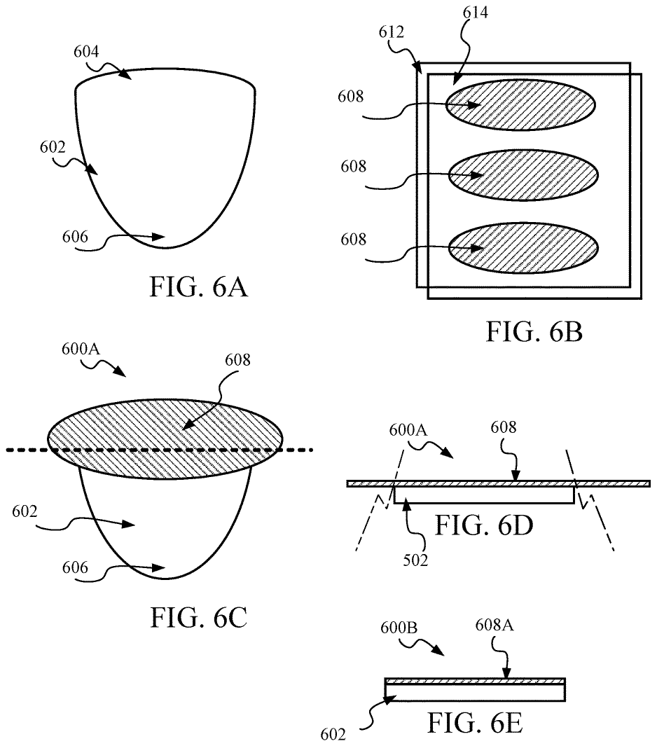

FIGS. 6A-6E illustrate an exemplary use of one or more adhesive surfaces according to embodiments described herein.

FIG. 6A illustrates an exemplary pick that may be used with embodiments of the exemplary adhesive surfaces shown and described herein. The exemplary pick 602 may be of any shape and/or size and may have a gripping portion 604 and a striking end 606.

FIG. 6B illustrates an exemplary kit of surface attachments. As illustrated, a plurality of surface attachments 608 are provided. As illustrated, the plurality of different surface attachments may be the same shape, size, and/or outer surface(s).

As illustrated in FIG. 6C, the surface attachment 608 may be provided with at least one dimension that is larger than a dimension of the pick 602 to which it is intended to be used.

As seen in FIG. 6D, which is a cross section of FIG. 6C, taken along the dotted line. The surface attachment 608 may be positioned on a gripping portion of the pick 602 and may extend beyond the terminal ends of the pick so that the surface attachment is larger in at least one dimension than then pick at the location in which the surface attachment contacts the pick.

After the surface attachment is coupled to the pick surface, the ends of the surface attachment that extend past the terminal ends of the pick may be folded over and coupled to the opposing side of the pick and/or may be removed so that the surface attachment terminates along a portion of the perimeter edge of the pick.

Referring to FIGS. 5B and 6B, the surface attachment(s) may be provided individually or as a set and may comprise a transfer sheet 512, 612 for storing, selling, and/or positioning the surface attachments on a pick surface. For example, one or more surface attachments may come on a transfer sheet 512, 612 with individual surface attachment(s) separated in a desired pattern and/or at a desired distance. The surface attachment(s) may be configured to be positioned and attached to the pick to transfer the surface attachment(s) from the transfer sheet 512, 612 in the desired pattern onto the pick 502, 602.

A second protective sheet 514, 614 may be positioned on top of the surface attachment(s) to protect the adhesion of the surface attachments during storage.

As shown and described herein, exemplary embodiments of the adhesive surface(s) may be positioned and stored between two laminate surfaces. The first surface may be a protective sheet configured to protect the adhesive surface(s) until used and may contact the inner surface configured to contact the pick surface. The protective sheet may be removed to expose one or more of the adhesive surfaces and the pick contacted and pressed against the exposed adhesive surface(s). The second surface may be a transfer sheet configured to contact the outward surface of the adhesive surfaces and may be removed after the one or more adhesive surfaces are attached to the pick surface, leaving the adhesive surface(s) attached to the pick.

In an exemplary embodiment, the transfer sheet 512, 612 may include a pick outline or other markers to assist with positioning the surface attachment(s) in a desired orientation and/or location on the pick.

The description shown and described herein may include attaching the surface attachment(s) according to embodiments described herein to an instrument pick and using the instrument pick to make noise from an instrument. The surface attachments may therefore be positioned and attached on the surface of an instrument pick away from a picking edge or corner and may be positioned and attached to facilitate a user gripping the pick.

The surface attachment(s) and methods of using the gripping devices may include one or more adhesive surfaces having a shape and/or size that may be larger than the pick to which it is intended to be attached. The surface attachment may be directly attached and/or may be stretch during attachment to the pick surface. The excess of the adhesive surface extending past the perimeter edge of the pick may thereafter be folded over and/or removed so that the adhesive surface and the pick are the same size and shape for at least a portion or all of the pick.

In an optional embodiment, the surface attachment may be cut to remove the excess of the surface attachment. In an optional embodiment, the surface attachment may be pulled against the terminal edge of the pick such that the surface attachment tears along the edge of the pick. Any overage of the surface attachment may therefore be cut, torn away, or otherwise removed from the pick.

Exemplary embodiments described herein, include an instrument pick having one or more surface attachments attached to the pick to improve grip and control of the grip on the pick by the musician.

The one or more surface attachments may be positioned on the pick to create a desired pattern and/or shape on the pick to generate a desired grip and/or feel of the pick.

The one or more surface attachments may be stacked on top of each other, overlap, and/or positioned adjacent to each other to generate a desirable thickness and/or cushion feel to the pick.

Exemplary embodiments of the methods for creating grip using the surface attachments as shown and described herein may also include powdering the adhesive surface to increase and/or decrease friction on the outer surface of the adhesive surface and/or control the stickiness of the adhesive surface. Any combination of powder, grit, sand, abrasive, etc. may be used to modify the surface adhesion of the surface attachment.

Exemplary embodiments of the surface attachment may comprise the surface texture including a non-adhesive substance pre-applied to the surface attachment to define a pre-formed surface texture and/or surface adhesive pattern. Exemplary embodiments of the surface attachment may include kits that include the surface attachment with at least one surface comprising an adhesive and a non-adhesive substance for the user to apply and create their own desired surface texture and/or adhesive level. Exemplary non-adhesive substances may be any substance to reduce and/or alter the adhesive level of the surface attachment and/or texture and/or feel of a surface of the surface attachment. For example, a non-adhesive substance may be powder, grit, sand, printing, etc.

Exemplary embodiments may use surface additives to modify and/or create desired surface texture, feel, friction, etc. For example, the surface attachment may include printing or ink deposition of a substance that may reduce friction and/or tackiness of a surface in portions of the surface attachment.

Exemplary embodiments may use any combination of non-adhesive substance (including any combination of powder, grit, sand, etc.), printing, surface contours, surface textures, or other features shown and described herein to add, modify, create, and/or define the surface features including shape, tactile feel, texture, adhesion, friction, grippiness, comfort, etc.

Exemplary embodiments of a pick to use with the adhesive surfaces shown and described herein may include grooved, contoured, textured, or otherwise featured surface to receive the surface attachment(s), position the surface attachment(s) in a desired location, and/or assist in the retention of the surface attachment(s) onto the pick's surface.

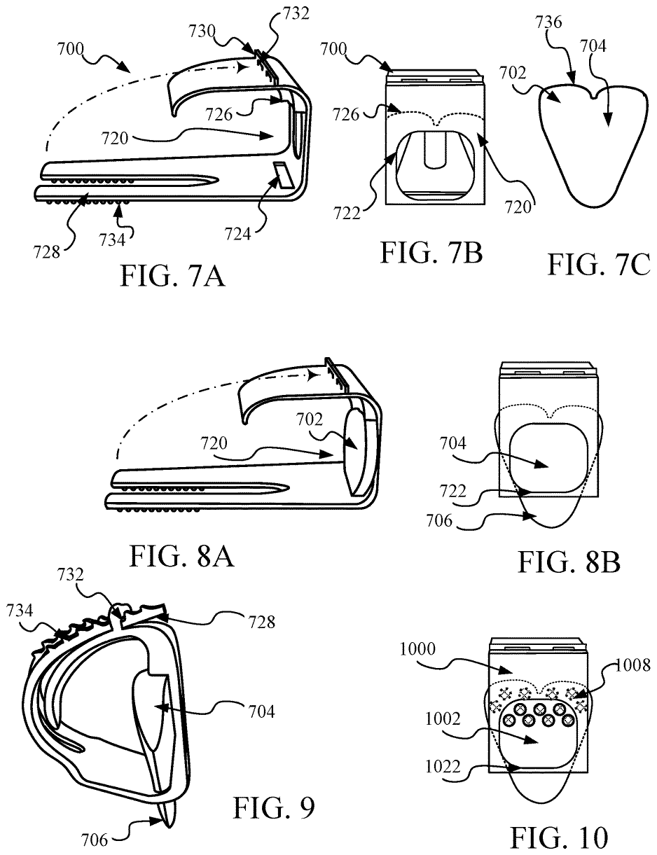

FIGS. 7A-10 illustrate a second embodiment, in which the device for improving grip on an instrument pick comprises devices that facilitate attachment of the pick to the user. As shown and described herein the attachment device 700 includes a cradle 720 for retaining the pick 702 and a connector or coupling the attachment device to a finger of the user.

The attachment device may comprise one or more apertures 722, 724 to permit contact with one or more surfaces of the pick 702.

In an optional example, one aperture 724 may be sized to permit the striking end of the pick through the aperture 724 but not permit the entire pick through the aperture 724 so that an edge of the one aperture contacts the perimeter edge of the pick to retain the pick in place.

In an optional example, another aperture 726 may be sized to permit contact with a gripping surface of the pick such as a side surface of the pick. The other aperture 726 may be smaller in diameter in at least one direction compared to the pick at the corresponding location of the pick to the cradle when in an in-use configuration. The cradle 720 having the other aperture may therefore be configured to retain the pick between the user's finger, and the inside surface of the cradle adjacent the second aperture edge, but allow contact with a pick surface through the other aperture by another of the user's fingers.

In an exemplary embodiment of the attachment device 700, the cradle 720 may comprise a ledge 726 to contact a portion of the perimeter edge of the pick to retain the pick in a desired position. The ledge 726 may be a projection on an inside surface of the attachment device 700 configured to contact a top terminal end of the pick during use. In an optional embodiment, the pick may be retained between the contact of the pick in the one aperture 724 and the ledge 726.

In an exemplary embodiment, the ledge 726 may be a shaped surface. The ledge may be configured to approximate the top terminal edge of the pick.

In an exemplary embodiment, the shaped surface of the ledge 726 and the top terminal edge of the pick 736 define mated surfaces. The mated surfaces approximate each other and fit together such that a contour of the top terminal edge of the pick approximates the shaped surface of the ledge.

As illustrated, the mated surfaces of the pick and ledge generally form the lobes of a heart. The configuration is for example only. Other mated surface may also be used such as other curves, zig-zags, projections and indentations, etc. Optional configurations of the mated surfaces may be configured such that when the mated surfaces are coupled, lateral movement of the pick relative to the cradle is reduced.

The attachment device may include a connector. The connector may be configured to couple the attachment device to a user's finger. The connector may include alternative connections, such as a mated projection and aperture, ratchet, button, hook and loop, tie, other coupling features and/or mated features, and any combination thereof.

Referring to FIG. 7A, the attachment device 700 may include one or more extensions 728 from the cradle 720 that are configured to wrap around a portion of the user's finger and extend through an attachment aperture 732 on an opposing side of the cradle from which the extensions project. The attachment aperture(s) 732 may be on a protrusion 730 on an exterior surface of the attachment device 700.

The extension(s) 728 may have a cross-sectional size and/or shape smaller than the size and/or shape of the attachment aperture(s) 732 so that one extension may fit through one of the attachment apertures.

In an exemplary embodiment, the connector may have a locking feature that retains the connector in a desired closed configuration during use. The locking feature may be any configuration in which the connector is maintained in a desired relative position during use of the attachment device.

For example, the locking feature may include hook and loop fastener, belt, ratchet, friction fit, buttons, indent/detent pairs, buttons, clasps, or other retention feature.

In the exemplary embodiment illustrated in FIG. 7A, the extension(s) 728 may have projections 734 extending therefrom that create a cross-sectional size and/or shape that is larger than attachment aperture such that the projections abut an edge around the attachment aperture and retain the extension in place and does not permit the projection to pass through the attachment aperture.

The projections and/or the material defining the attachment aperture may be flexible so that the projections and/or the attachment aperture may deform to permit the projections to pass through the attachment aperture in at least one direction.

The projections may be shaped to facilitate passage through the attachment aperture in a first direction but impede passage through the attachment aperture in a second direction, opposite the first direction. For example, the projections may have a tapered end and a stepped end. The stepped end may be configured to abut a perimeter defining the attachment aperture to retain the projection in place relative to the aperture and impede the passage of the extension through the aperture in one direction. The tapered end of the projection may be configured to slide through the aperture and facilitate the deformation of the aperture to extend the aperture and permit the projection to pass therethrough allowing movement of the extension through the aperture in a second direction.

The projections and/or material defining the attachment aperture may be flexible to permit passage of the projections through the attachment aperture under application of sufficient force to the extensions to pull the extension through the attachment aperture but may retain the extension in a desired relative position and not permit the passage of the projections through the attachment aperture with insufficient force applied on the extension.

FIGS. 8A and 8B illustrate a attachment device 700 of FIGS. 7A-7B with a pick 702 positioned therein.

FIG. 8A illustrates a side view of the attachment device according to embodiments described herein. It may include a passive shape in which the cradle 720 is generally planar or may include a curved configuration. The cradle is shaped to receive a portion of the pick. The passive shape of the attachment device may include a first side of the connector extending from a first end of the cradle in generally a perpendicular direction to the surface of the cradle. The passive shape of the attachment device may include a second side of the connector extending from a second end of the cradle in generally a perpendicular direction to the surface o the cradle. The first side and the second side of the connector are therefore configured to generally extend parallel to each other.

Referring to FIG. 8B, the pick 702 may be fit within the cradle 720 of the attachment device 700. The picking end 706 of the pick 702 may extend through the aperture 724 of the attachment device 700 to provide access to the picking end of the pick during use. The pick, when positioned in the cradle, may have a gripping portion 704 exposed through the aperture 722 of the cradle such that a user may contact the pick surface during use.

FIG. 9 illustrates an exemplary attachment device 700 in a closed configuration in which the first side and second side of the connector is closed and attached together. In the closed configuration, the attachment device 700 may be configured to define an enclosed ring configured to have a finger of the user positioned therein.

As illustrated, the extensions 720 defining a first side of the connector may be configured to fit through the attachment aperture to secure the first side of the connector to the second side of the connector. As illustrated, the extension 720 may include shaped protrusions 734 to impede the passage of the extension back through the attachment aperture such that the attachment device is maintained in the closed configuration.

In an exemplary embodiment, the attachment device 700 comprises a flexible material. The flexible material permits comfortable deformation of the attachment device around the user's finger to couple the pick to the user's finger.

FIG. 10 illustrates an exemplary embodiment in which the devices for improving grip shown and described herein are used in conjunction.

The surface attachment(s) and/or attachment device(s) may be used in combination.

In an exemplary embodiment, the surface attachments may be used to couple the pick to the attachment device.

In an exemplary embodiment, the surface attachment may be coupled to the pick surface and exposed to the user through an aperture of the attachment device.

As seen in FIG. 10, the surface attachment 1008 may be positioned on a pick 1002. The pick 1002 may be positioned within the cradle of the attachment device 1000. As illustrated, the surface attachment(s) 1008 may be positioned such that one or more complete or portions of surface attachment(s) are positioned between the pick and the cradle of the attachment device. The surface attachment may therefore provide additional security of the pick to the attachment device. One or more of the surface attachments may also or alternatively be positioned such that one or more complete or portions of surface attachment(s) are exposed on the surface of the pick, such as through one or more apertures 1022 of the attachment device. A user may therefore directly contact one or more surface attachments to further improve grip on the pick.

In an exemplary embodiment, the pick may include one or more surface attachments on approximately two-thirds or less of a pick surface, such as one-half, one-third, or other desired proportion.

Exemplary embodiments of the surface attachments include pressure-sensitive adhesives. The surface attachments may be adhesive dots or globules of adhesive, which allow attachments to float above a page. To make adhesive dots, you can cut a piece of wax paper around the size that you want to fill with dots and then form the dots by squeezing lightly to form a round dot shape.

The surface attachments may be positioned and stored on a sheet between two laminate surfaces. The first surface may protect the adhesives until used. The first surface may be removed to expose one or more of the surface attachments and the pick contacted and pressed against the exposed adhesive. The second surface may then be removed, leaving the adhesive attached to the pick.

The surface attachment(s) may be positioned on the pick to create a desired, shape, or surface contour on the pick to generate a desired grip and/or feel of the pick.

The tops of the adhesive portions may be textured or contoured to generate a desired feel.

The tops of the adhesive portions may also or alternatively be powdered to reduce or control the stickiness of the adhesive.

Exemplary embodiments of the surface attachments may also be used to store the pick when not being played. For example, the adhesive of the surface attachment may be sufficient to couple the pick to storage surface, such as an instrument body, stand, or other surface when the pick is not being used with the instrument. The adhesive surface may be sufficiently weak that the pick may be removed from the storage surface without damage to the pick, storage surface, and/or surface attachment. The surface attachments shown and described herein may therefore be used as a method to store a pick when not in use.

There are issues such as lack of sufficient grip and control over existing instrument picks, limited customization options for grip surfaces and textures, absence of ergonomic contours or optimized designs, and challenges in temporary storage and retrieval of picks. Therefore, the present invention provides a gripping system for an instrument pick with adhesive surfaces and/or attachment devices to assist in grip and control. The adhesive surfaces may come in patterns, be contoured, or shaped to improve grip and control over the pick.

The purpose of this invention is to provide a gripping system for an instrument pick that enhances grip and control during playing. The solution may include adhesive dots positioned on a gripping end of an instrument pick to assist in grip and control. The adhesive dots may come in different sizes, shapes, surface contours, and/or patterns to create a desired feel. The adhesive dots may be contoured or shaped to improve grip and control over the pick. The pick may also incorporate grip-enhancing features like a tacky material, an uneven surface, concave indentations, ergonomic grooves, or a plurality of protuberances.

Exemplary embodiments of the invention encompasses a method of supplying and applying the adhesive dots to the pick, including generating one or more adhesive dots on a sheet of paper in a desired position and/or pattern, permitting the user to remove a protective sheet, attach one or more of the adhesive dots to the pick, and remove the adhesive dots from the sheet, retaining them on the pick in the desired pattern and/or position.

A gripping system for an instrument pick comprises a plurality of adhesive dots positioned on a gripping end of the pick to assist in grip and control. The adhesive dots are arranged in a desired pattern, such as a square grid array, to create a desired feel and improve grip over the pick. The adhesive dots may be circular in shape, with a diameter and spaced apart in a grid and/or pattern on one or both sides of the pick.

The adhesive dots are composed of a pressure-sensitive adhesive material that adheres to the pick surface without leaving residue or damaging the finish.

The gripping system may further include a suction cup principle for adhesion, allowing the pick to be readily stored momentarily or indefinitely by attaching it onto a nearby object, such as a guitar body. The suction cups are formed integrally with a resilient or rubbery material layer, such as vinyl or a silicone polymer, on one or both sides of the pick. The suction cups may have a shape similar to well-known suction cups, defined by a concave curved surface. The suction cup are articulated and can flex to conform to the surface they are adhered to, providing a secure grip.

The gripping system may be applied to practically any known stringed musical instrument pick of any size, shape, and material. The adhesive dots can be customized in terms of size, shape, density, and material to achieve the desired grip, release, and performance characteristics under different playing conditions.

A method of supplying and applying the gripping system to an instrument pick includes generating one or more adhesive dots on a sheet of paper in a desired position and pattern. The adhesive dots may be arranged in a circular, square, or rectangular patch, and the patch may extend from one-third to two-thirds of the pick dimension.

The user removes a protective sheet from the adhesive dot patch, attaches the pick to the exposed adhesive surface, and then removes the adhesive dots from the sheet, retaining them on the pick in the desired pattern and position. The adhesive dots may be contoured or shaped to improve grip and control over the pick, such as by incorporating concave indentations, ergonomic grooves, or a plurality of protuberances.

The gripping system may also incorporate a tacky material, an uneven surface, or a combination of these features to enhance grip and control over the pick. The pick itself may have a cross-sectional shape that is not limited to a straight line, such as a wavy line, arcuate line, polygon, circle, oval, slanting line, convex line, or concave line, further optimizing grip and control during playing.

The purpose of this invention is to overcome the drawbacks in the existing technology and provide an instrument pick with improved grip and control for the musician. The instrument pick comprises one or more adhesive portions attached to the pick. The adhesive portions may be positioned on the pick to create a desired pattern and/or shape to generate a desired grip and/or feel. The adhesive portions may be stacked on top of each other to generate a desirable thickness and/or cushion feel. The tops of the adhesive portions may be textured or contoured to generate a desired feel, such as convex surfaces, concave surfaces, and combinations thereof on opposing lateral sides bounded by an outer perimeter that also provides curved, straight, and combination edges. The curved surfaces may provide additional surface area over a given cross section to create a greater or easier contact for the player with the stringed instrument.

The tops of the adhesive portions may also be powdered to reduce or control the stickiness of the adhesive.

The surface attachments may be colored, printed, and/or otherwise decorated to provide visual affects on the pick.

The surface attachments may include components contained therein and/or thereon. For example, components may include electronic components such as, for example, chip(s), diode(s), solar cell(s), batter(y/ies), or other electronic element(s). Electronic components may be used to produce colors and/or lights, store information, etc. Electronic components may communicate with another electronic device such as a mobile phone of a user to retrieve the information and/or control the electronic component within the surface attachment.

An instrument pick comprises a body and one or more adhesive portions attached to the body. The adhesive portions are positioned on the body to create a desired pattern and shape, generating a desired grip and feel for the musician.

The adhesive portions may be stacked on top of each other to achieve a desirable thickness and cushion feel.

The tops of the adhesive portions may be textured or contoured, such as convex surfaces, concave surfaces, and combinations thereof on opposing lateral sides bounded by an outer perimeter that also provides curved, straight, and combination edges.

The tops of the adhesive portions may also be powdered to reduce or control the stickiness of the adhesive.

An instrument pick comprises a body and one or more adhesive portions attached to the body. The adhesive portions are positioned on the body to create a desired pattern and shape, generating a desired grip and feel for the musician. The adhesive portions may be stacked on top of each other to achieve a desirable thickness and cushion feel. The tops of the adhesive portions may be textured or contoured, such as convex surfaces, concave surfaces, and combinations thereof.

The tops of the adhesive portions may also be powdered to reduce or control the stickiness of the adhesive.

A device is shown and described herein for improving grip on an instrument pick. The device may include a surface attachment defining a first side and a second side, and an adhesive surface on the first side of the surface attachment configured to couple the device onto a surface of the instrument pick.

The device may also include a second adhesive surface on the second side of the surface attachment configured to increase friction for holding the instrument pick.

The device may also include a plurality of surface attachments configured to be positioned on the instrument pick.

The device may also include a transfer sheet in which the plurality of surface attachments are positioned on the transfer sheet with the second side of the surface attachment contacting the transfer sheet and the adhesive surface exposed to be attached to the instrument pick.

The plurality of surface attachments may be positioned on the transfer sheet in a spaced configuration configured to be a position of the surface attachments when coupled to the surface of the instrument pick.

The plurality of surface attachments may include any combination of different shapes, contours, surface textures, or tackiness of the adhesive surface for a user to select a desired surface attachment from the plurality of surface attachments.

The plurality of surface attachments may be shaped to be positioned on top of each other and define a contoured surface.

The transfer sheet may include a pick outline configured to assist a user in aligning the instrument pick for placement of the surface attachments onto the surface of the pick.

The second side of the surface attachment may include a contoured surface.

The surface attachment may include a hole from the first side to the second side configured to permit direct access to the surface of the instrument pick when the surface attachment is coupled to the instrument pick.

The first side and the second side of the surface attachment may be on opposite sides of the surface attachment, and the adhesive surface and second adhesive surface is part of the surface attachment and from a tackiness of a material of the surface attachment.

The surface attachment may be flexible to contour to the surface of the instrument pick and compressible to provide cushion when pressed by a user of the instrument pick.

The surface attachment may include a pressure-sensitive adhesive.

The surface attachment may be pre-formed in a given shape for direct attachment onto the surface of the instrument pick.

The device may also include a kit also including a material for reducing a tackiness of the surface attachment,

Also shown and described herein is a method of improving a surface grip of the instrument pick. The method includes providing the device for improving grip according to embodiments described herein; aligning the pick with the surface attachment; and pressing the surface attachment against the surface of the instrument pick.

The method may also include removing the surface attachment from a transfer sheet configured to store the surface attachment when not in use.

The method may also include gripping the instrument pick through the surface attachment.

The method may also include adjusting a tackiness of the surface attachment by applying a material to the second side of the surface attachment.

The method may also include stacking a second surface attachment onto the surface attachment after the surface attachment has been coupled to the instrument pick.

The method may also include positioning the surface attachment on the instrument pick so that a portion of the surface attachment extends past a terminal edge of the instrument pick and removing the portion of the surface attachment that extends past the terminal edge of the instrument pick from another portion of the surface attachment overlaying the surface of the instrument pick.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A device for improving grip on an instrument pick comprising:
a surface attachment defining a first side and a second side; and
an adhesive surface on the first side of the surface attachment configured to couple the device onto a surface of the instrument pick.

2. The device of claim 1, further comprising a second adhesive surface on the second side of the surface attachment configured to increase friction for holding the instrument pick.

3. The device of claim 2, further comprising a plurality of surface attachments configured to be positioned on the instrument pick.

4. The device of claim 3, further comprising a transfer sheet in which the plurality of surface attachments are positioned on the transfer sheet with the second side of the surface attachment contacting the transfer sheet and the adhesive surface exposed to be attached to the instrument pick.

5. The device of claim 4, wherein the plurality of surface attachments are positioned on the transfer sheet in a spaced configuration configured to be a position of the surface attachments when coupled to the surface of the instrument pick.

6. The device of claim 4, wherein the plurality of surface attachments comprises any combination of different shapes, contours, surface textures, or tackiness of the adhesive surface for a user to select a desired surface attachment from the plurality of surface attachments.

7. The device of claim 4, wherein the plurality of surface attachments are shaped to be positioned on top of each other and define a contoured surface.

8. The device of claim 4, wherein the transfer sheet comprises a pick outline configured to assist a user in aligning the instrument pick for placement of the surface attachments onto the surface of the pick.

9. The device of claim 2, wherein the second side of the surface attachment comprises a contoured surface.

10. The device of claim 2, wherein the surface attachment comprises a hole from the first side to the second side configured to permit direct access to the surface of the instrument pick when the surface attachment is coupled to the instrument pick.

11. The device of claim 2, wherein the first side and the second side of the surface attachment are on opposite sides of the surface attachment, and the adhesive surface and second adhesive surface is part of the surface attachment and from a tackiness of a material of the surface attachment.

12. The device of claim 2, wherein the surface attachment is flexible to contour to the surface of the instrument pick and compressible to provide cushion when pressed by a user of the instrument pick.

13. The device of claim 2, wherein the surface attachment comprises pressure-sensitive adhesives.

14. The device of claim 2, wherein the surface attachment is pre-formed in a given shape for direct attachment onto the surface of the instrument pick.

15. The device of claim 1 further comprising a kit also including a material for adjusting a tackiness of the surface attachment.

16. A method of improving a surface grip of the instrument pick, comprising:
providing the device of claim 1;
aligning the pick with the surface attachment; and
pressing the surface attachment against the surface of the instrument pick.

17. The method of claim 16, further comprising removing the surface attachment from a transfer sheet configured to store the surface attachment when not in use.

18. The method of claim 16, further comprising gripping the instrument pick through the surface attachment.

19. The method of claim 18, further comprising adjusting a tackiness of the surface attachment by applying a material to the second side of the surface attachment.

20. The method of claim 16, further comprising stacking a second surface attachment onto the surface attachment after the surface attachment has been coupled to the instrument pick.
